(19) United States
(12) Patent Application Publication
(10) Pub. No.: US 2011/0051036 A1
(43) Pub. Date: Mar. 3, 2011

(54) Liquid Crystal Display Device

(75) Inventors: Yoshiharu Yamashita, Yokohama (JP); Katsunari Sato, Toda (JP)

(73) Assignee: Hitachi Consumer Electronics Co., Ltd., Tokyo (JP)

(21) Appl. No.: 12/786,764

(22) Filed: May 25, 2010

(30) Foreign Application Priority Data
Aug. 31, 2009 (JP) 2009-200119
Aug. 31, 2009 (JP) 2009-200127

(51) Int. Cl. G02F 1/1335

(52) U.S. Cl. 349/62

(57) ABSTRACT

The invention makes patterns which may show, according to the positioning of light guide plates, along the vertical direction of a display screen of a side-edge type liquid crystal display device inconspicuous. This is achieved by disposing light guide plates so as to guide the illumination light from light sources, for example, LEDs along the vertical direction of the display screen. The vertically guided illumination light is reflected, with reflection sheets also facilitating the reflection, at rear sides of the light guide plates and is, after traveling through a diffusion sheet to be made more uniform, further guided to liquid crystals. Even though boundaries between light guide plates are generally more conspicuous along the vertical direction of a display screen than along the horizontal direction, first guiding the illumination light into a vertical direction removes the problem of such boundaries conspicuously showing along the vertical direction.

### INCORPORATION BY REFERENCE

This application relates to and claims priority from Japanese Patent Application No. 2009-200119 filed on Aug. 31, 2009 and Japanese Patent Application No. 2009-200127 filed on Aug. 31, 2009, the entire disclosure of which are incorporated herein by reference.

### BACKGROUND OF THE INVENTION

(1) Field of the Invention

The present invention relates to a liquid crystal display device, particularly, a liquid crystal display device using LEDs as light sources for a backlight device.

(2) Description of the Related Art

In recent years, with TV broadcasting digitalization and the introduction of high-definition broadcasting being promoted, large-sized (large-screen), thin image display devices, i.e. flat panel displays (FPDs), are in demand. Liquid crystal display (LCD) devices are among conventional large-sized, thin flat panel displays. A thin LCD device to be realized requires a thin backlight device for incorporation therein.

Conventional backlight devices for LCD devices are surface light source devices which output surface light using linear or point, primary light sources. Such surface light source devices each use, for example, light emitting diodes (LEDs) or a cold cathode fluorescent lamp (CCFL) as a primary light source and light guide plates for converting light fluxes emitted from the primary light source into surface light. A surface light source device using plural combinations of light guide plates and light sources, like those described above, which are two-dimensionally arranged so as to acquire a relatively wide emission area are referred to as tandem-type surface light source devices.

Techniques for such tandem-type surface light source devices have been disclosed, for example, in Japanese Patent Application Laid-Open Nos. 2006-286638 and 2001-93321.

### SUMMARY OF THE INVENTION

As stated above, LCD devices have been growing thinner and larger in screen size. The tandem-type surface light source devices are advantageous in making LCD devices thinner and larger in screen size.

In a tandem-type surface light source device, light sources are, as described in Japanese Patent Application Laid-Open Nos. 2006-286638 and 2001-93321, installed such that the light fluxes generated by them travel along the horizontal direction of a display screen (for example, leftwardly or rightwardly along the display screen) to be then incident to light guide plates.

According to the conventional techniques, an image displayed on a display screen, with the light from light sources inputted rightwardly, as seen from the front side of the display screen (from the user's side), to light guide plates, appears bright when viewed from the right side and dark when viewed from the left side. This is because viewing the display screen from the right side is seeing the light sources from in front of the light sources, whereas viewing the display screen from the left side is seeing the light sources from behind the light sources.

As described above, when the light from light sources is arranged to be incident to light guide plates along the horizontal direction of a display screen, the image brightness at a horizontal viewing angle becomes asymmetric between when the display screen is viewed from the right side and when it is viewed from the left side. This causes image brightness unevenness dependent on the horizontal viewing angle. Since the user, in many cases, views the display screen at a horizontal angle with respect to a line perpendicular to the display screen, it is preferable to minimize the image brightness unevenness dependent on the horizontal viewing angle of the user.

Furthermore, in a tandem-type surface light source device, plural combinations of light guide plates and light sources are two-dimensionally arranged. This lowers the assembly work efficiency (assembly workability) for the surface light source device. In addition, there can be cases where a light source for inputting light to a first light guide plate comes in physical contact with a second light guide plate adjacent to the light source to possibly damage the light source.

The present invention has been made in view of the above problems, and an object of the present invention is to provide a technique which makes it possible, in an LCD device using a tandem-type backlight device including plural combinations of light sources and light guide plates, to reduce the image brightness unevenness dependent on the horizontal viewing angle and realize high-quality image display.

Another object of the present invention is to provide a technique, related to an LCD device using a tandem-type backlight device including plural combinations of light sources and light guide plates, which is advantageous in improving assembly workability and protecting the light sources.

It is a first characteristic of the present invention that a liquid crystal display (LCD) device for displaying an image using a liquid crystal panel includes a plurality of light sources and a plurality of light guide plates to which light from the plurality of light sources is incident and which output the light incident from the plurality of light sources to the liquid crystal panel as surface light. Furthermore, in the LCD device: the plurality of light guide plates are arranged along a vertical direction of the liquid crystal display device, each of the plurality of light guide plates having a rectangular shape longitudinally extending along a horizontal direction of the liquid crystal display device; an incident surface, to which light is incident from a corresponding one of the plurality of light sources, of each of the plurality of light guide plates faces up; and each of the plurality of light sources is disposed to emit light downwardly along the liquid crystal panel toward a corresponding one of the plurality of light guide plates.

It is a second characteristic of the present invention that an LCD device for displaying an image using a liquid crystal panel includes: a plurality of light sources; a plurality of light guide plates to which light from the plurality of light sources is incident and which output the light incident from the plurality of light sources to the liquid crystal panel as surface light; a plurality of reflection sheets disposed behind the plurality of light guide plates; and a plurality of support members for supporting the plurality of reflection sheets from behind. Furthermore, in the LCD device: the plurality of light guide plates are arranged along a vertical direction of the liquid crystal display device, each of the plurality of light guide plates having a rectangular shape longitudinally extending along a horizontal direction of the liquid crystal display device; an incident surface, to which light is incident from a corresponding one of the plurality of light sources, of each of the plurality of light guide plates faces up; each of the plurality of light sources is disposed to emit light downwardly along the liquid crystal panel toward a corresponding one of the plurality of light guide plates; and the plurality of support members each have a hole to enclose one of the plurality of light sources.

According to the first characteristic of the present invention, the light from light sources is incident to light guide plates along the downward direction of a liquid crystal panel, so that the image display brightness on the display screen is approximately the same between when the display screen is viewed from the right side with a horizontal viewing angle and when the display screen is viewed from the left side with the same horizontal viewing angle. Thus, the image brightness unevenness dependent on the horizontal viewing angle can be reduced.

According to the second characteristic of the present invention, an LCD device using illumination light emitted from light sources for backlighting can be provided in which the amount of light outputted from the light sources is effectively used and which can be fabricated with high workability while protecting the light sources from possible damage.

### BRIEF DESCRIPTION OF THE DRAWINGS

These and other features, objects and advantages of the present invention will become more apparent from the following description when taken in conjunction with the accompanying drawings wherein:

FIG. 1A is a front view of a substrate of a liquid crystal display (LCD) device according to an embodiment of the present invention;

FIG. 1B is a front view of support members of the LCD device according to the embodiment;

FIG. 1C is a front view of reflection sheets of the LCD device according to the embodiment;

FIG. 1D is a front view of light guide plates of the LCD device according to the embodiment;

FIG. 2A is a front view of a support member of the LCD device according to the embodiment;

FIG. 2B is a bottom view of a support member of the LCD device according to the embodiment; and

FIG. 3 is a side view of the LCD device according to the embodiment.

### DETAILED DESCRIPTION OF THE EMBODIMENT

An embodiment of the present invention will be described below with reference to drawings.

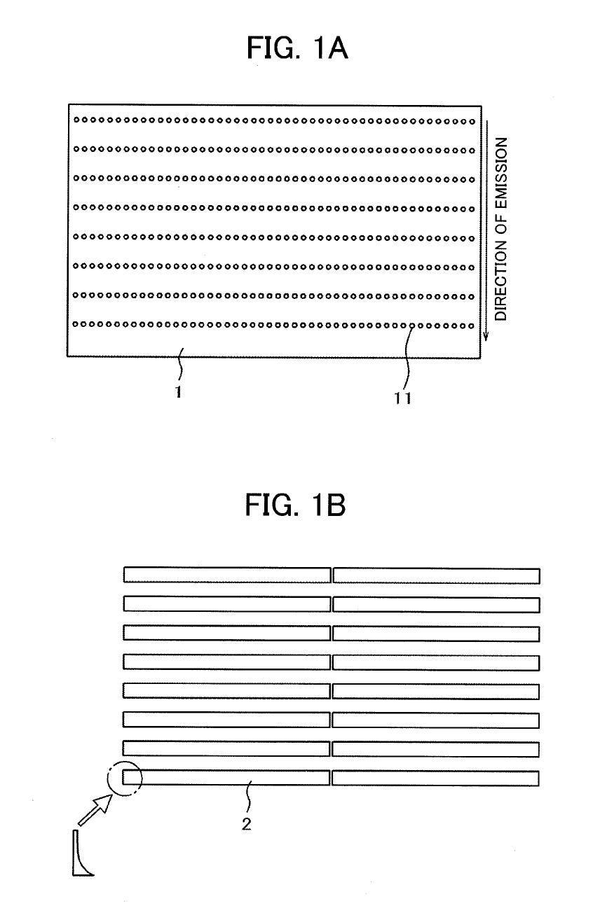

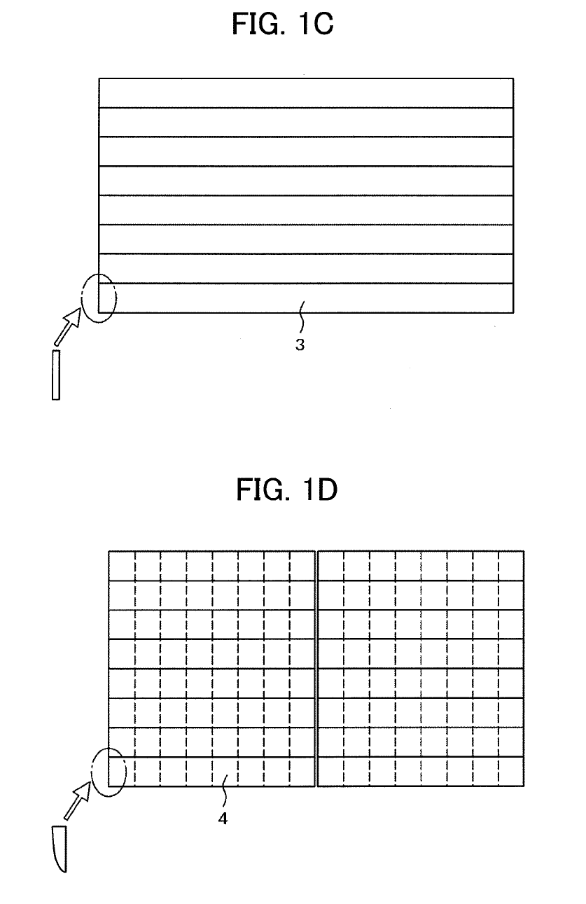

FIGS. 1A to 1D are front views of components of an LCD device according to an embodiment of the present invention with FIG. 1A showing a substrate, FIG. 1B showing support members, FIG. 1C showing reflection sheets, and FIG. 1D showing light guide plates. These drawings are for making the following description of the embodiment of the present invention easier to understand, so that components not directly associated with the invention may be omitted in them. In the display section of the LCD device, the substrate (FIG. 1A), support members (FIG. 1B), reflection sheets (FIG. 1C), and light guide plates (FIG. 1D) are put together face to face, arranged in the mentioned order in the rear-to-front direction of the display section.

Referring to FIG. 1A, the substrate 1 is provided with plural LEDs 11 used as light sources for a backlight device. Though the LEDs 11 shown in FIG. 1A are arranged in an array of 48 LEDs horizontally and eight LEDs vertically, they may be arranged differently. With highly luminous LEDs recently being available, an LED array of this size can provide brightness good enough even for a 42-inch screen. In the present example, the LEDs 11 are of a side view type to emit light in a direction parallel with their electrode surface.

Referring to FIG. 1D, the light guide plates 4 each have a rectangular shape with a longer side extending horizontally. In the example arrangement shown in FIG. 1D, the light guide plates 4 are arranged in two side-by-side columns with each column including eight vertically arranged light guide plates, each light guide plate extending horizontally. In FIG. 1D, solid lines denote boundaries of the light guide plates. Each of the light guide plates 4 shown in FIG. 1D has eight blocks delimited, for example, by grooves as denoted by broken lines. Namely, in the present embodiment, each of the light guide plates 4 includes eight integrally combined light guide blocks. When the light guide plates 4 are used in combination with the substrate 1 shown in FIG. 1A, each of the light guide blocks is to guide the illumination light emitted by three LEDs 11. The light guide plates 4 each have an incident surface to which the light emitted from the corresponding LEDs is incident and which faces upward along the display screen.

Unlike conventional light guide plates, the light guide plates 4 are configured to guide the illumination light mainly in the downward direction of the display screen as indicated by the broken-line arrow in FIG. 1A. The illumination light changes its direction by being reflected mainly by a surface on the deeper side (i.e. on the rear side that is opposite to the image display side) of each of the light guide plates 4, then travels toward the front side of the LCD device. Referring to FIG. 1D, a left side view of the light guide plate block in the lower left corner is also shown. Because the amount of illumination light decreases as the illumination light travels downward, it is necessary to make reflected illumination light more easily available at lower positions. Hence, each of the light guide plates 4 is shaped like a wedge, as seen from a side, with its rear side curved like an arc making it thinner toward its lower edge as shown in FIG. 1D.

Each of the light guide plates 4 is fixed in position mainly at its upper part for securer installation. In FIG. 1D, a clearance is shown provided between the light guide plates 4 arranged on the left side and those arranged on the right side. Obviously, the clearance is preferred to be as small as possible. Each of the light guide plates 4 is formed of, for example, an acrylic resin, so that its expansion or contraction caused by a temperature change taking place while it is used in a display device can pose a problem. It is therefore advisable to fix the horizontal position of each of the light guide plates 4 mainly at a part thereof corresponding to a horizontal middle part of the display screen while leaving a lateral outer end part thereof somewhat movable horizontally so as to absorb its expansion or contraction in the horizontal direction. Shifting of components of an LCD device caused by temperature changes can affect the quality of image display by the device. When the horizontal position of each of the light guide plates 4 is fixed in the above manner, however, the influence of shifting of the light guide plates 4 on the quality of image display shows only in laterally outer parts, to which not so much attention is given by the viewer, of the display screen.

In the example arrangement shown in FIG. 1C, eight reflection sheets 3 are arranged vertically, each positioned to extend horizontally. The reflection sheets 3 may each have a uniform thickness as shown, in a lower left part of FIG. 1C, by a left side view of the lowest positioned reflection sheet. The reflection sheets 3 are installed such that their front sides are in contact with the rear sides of the light guide plates 4. The reflection sheets 3 each have a white surface so as to better reflect the illumination light.

As described above, the LCD device of the present embodiment includes plural rectangular light guide plates vertically arranged with their longer sides extending along the horizontal direction of the rectangular screen (liquid crystal panel) of the LCD device. The horizontally positioned rectangular light guide plates receive the light emitted vertically downwardly, as indicated by the broken-line arrow shown in FIG. 1A, from the LEDs 11 used as light sources. When an image of one color (for example, white) is displayed on the display screen of the LCD device configured as described above, the optical intensity distribution along the horizontal direction of the display screen is approximately uniform in a range of horizontal viewing angle of a viewer. Therefore, the image brightness on the display screen is approximately the same whether the image is viewed at a certain horizontal angle (for example, at 30 degrees with respect to a line perpendicular to the display screen) from the right side or from the left side. Thus, the image brightness unevenness dependent on the horizontal viewing angle is reduced to substantially eliminate the display brightness asymmetry between when the display screen is viewed from the right and when it is viewed from the left.

Referring to FIG. 1B, the support members 2, unlike the reflection sheets 3 and the light guide plates 4, need not be as large as the display section of the LCD device. Their area may be, for example, about one third to one half of that of the display section. In the example arrangement shown in FIG. 1B, the identical support members 2 are arranged in two side-by-side columns with each column including eight vertically arranged support members. The support members are formed, for example, by molding a plastic material. They each have a front side curved like an arc, as shown by a side view in a lower left part of FIG. 1B, so as to fit the curved rear side of the light guide plates 4. Thus, with the reflection sheets 3 and the light guide plates 4 having mutually correspondingly curved sides, when they are put together as being described later, they can be positioned not to easily come off each other. Each of the support members, therefore, need not support the entire part, including even a gently curved upper half part, of the corresponding light guide plate, and, as described above, it is good enough for each support member to support about a lower one third or one half part of the corresponding light guide plate.

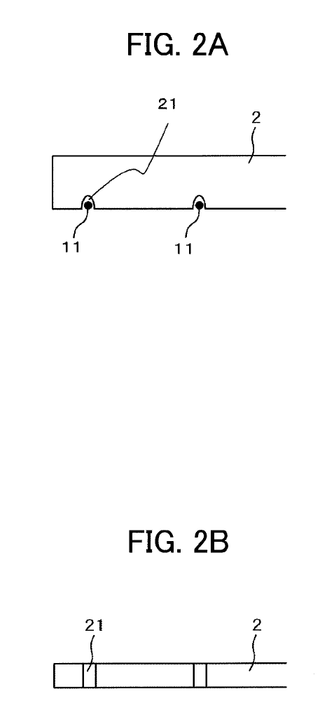

FIGS. 2A and 2B show enlarged views of a left end portion of each of the support members 2 shown in FIG. 1B with FIG. 2A showing a front view and FIG. 2B showing a bottom view. The support members 2 each have LED grooves 21, not shown in FIG. 1B not to complicate the drawing. To be combined with the substrate 1 shown in FIG. 1A, each of the support members 2 is required to have 24 LED grooves. When the support members 2 and the substrate 1 are put together, the LED grooves 21 protect the LEDs 11 from possible damage during assembly work and function to reflect the illumination light emitted from the LEDs 11 downwardly toward the light guide plates 4. The LED grooves 21 shown in FIG. 2B are therefore preferred to be made highly reflective, for example, by making them white.

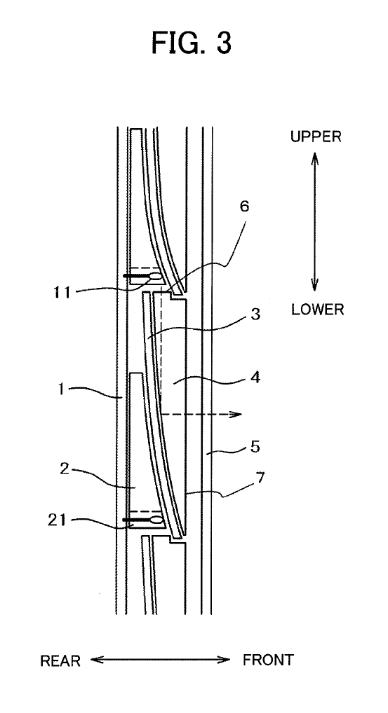

An assembled state of the above components will be described with reference to FIG. 3.

FIG. 3 is a side view of the LCD device according to the present embodiment. The LCD device includes a diffusion sheet 5 which is not among the components described above. The diffusion sheet 5 is for further uniformizing the illumination light guided by the light guide plates 4. Though not illustrated, a liquid crystal panel is provided on the right of the diffusion sheet 5 as seen in FIG. 3. Namely, as indicated by the solid-line arrow shown at the bottom of FIG. 3, the leftward direction as seen in FIG. 3 is the rearward direction (toward the rear side) of the LCD device and the rightward direction as seen in FIG. 3 is the frontward direction (toward the front side) of the LCD device. The downward direction is indicated by the solid-line arrow shown in an upper part of FIG. 3. Though, to make the drawing easier to understand, the components are illustrated with clearances provided between them, they are mutually in contact in reality. Also, in FIG. 3, the LEDs 11 are illustrated in solid line, even though they are not directly visible from a side.

Referring to FIG. 3, the substrate 1 is attached with the support members 2. Each of the LEDs 11 provided on the substrate 1 is positioned inside the corresponding LED groove 21 provided in the corresponding support member 2. The LED grooves 21 are each sized not to come in contact with the corresponding LED 11 when the support members 2 are attached to the substrate 1. Namely, when the support members 2 are seen from the front side of the LCD device, there is a margin (gap) of about 1 to 5 mm between the inner wall of each LED groove 21 and the LED 11 placed inside the LED groove 21 as shown in FIG. 2A. Therefore, even when the support members 2 are displaced or expanded downward by being heated, the inner wall of each LED groove 21 and the LED 11 placed inside the LED groove 21 do not easily come in physical contact. The reflection sheets 3 are fixed in position by the support members 2 to be in contact with both the support members 2 and the light guide plates 4. The light guide plates 4 are positioned such that the light incident surface 6 of each light guide plate 4 faces upward with the corresponding LED 11 disposed above the light incident surface 6, so that the illumination light emitted from the LED 11 is incident to the light incident surface 6. The LCD device of the present embodiment is, as described above, of a side edge type which is advantageous in making the LCD device thinner. The illumination light guided mainly vertically as indicated in broken line in FIG. 3 is reflected, with the reflection sheets 3 also facilitating the reflection, at the rear surfaces of the light guide plates 4 and is outputted as surface light from the light outputting surfaces 7 of the light guide plates 4 to be then guided to the diffusion sheet 5. The light guided to the diffusion sheet 5 is further guided as uniformly diffused light to liquid crystals, not illustrated.

As shown in FIG. 3, each light guide plate 4 has a small depressed part at its top to receive lower end portions of the light guide plate and the reflection sheet both placed immediate above it. This configuration serves to make the light guide plate boundaries visually less conspicuous.

In FIG. 3, the mechanism for holding individual components are omitted to avoid complicating the drawing. Each of the support members 2, for example, may have a mechanism in a lower end portion thereof for holding the corresponding light guide plate 4 or the diffusion sheet 5, and other components may also have, for example, cutout portions for use in keeping them in position.

The proportions among the dimensions along different directions of each component shown in the accompanying drawings only represent example dimensional proportions which may be optionally changed. The dimensional proportions among different components are also optional. The reflection sheets 3, for example, may be thinner than shown in the accompanying drawings relative to the thickness of the support members 1 or light guide plates 4.

As described above, in the present embodiment, plural rectangular light guide plates are vertically arranged with each light guide plate longitudinally extending along the horizontal direction of a display screen (LCD panel), and the light emitted from LEDs 11 used as light sources is downwardly inputted to the horizontally longitudinal light guide plates. Therefore, the image brightness unevenness dependent on the horizontal viewing angle is reduced, and the image brightness asymmetry between when the screen is viewed from the right side and when it is viewed from the left side is substantially eliminated. This arrangement also produces an effect to make boundaries between the vertically arranged light guide plates 4 visually less conspicuous. Furthermore, the illumination light emitted from the LEDs 11 is guided effectively to the light guide plates 4, the guided light including the light reflected from the inner surfaces of the LED grooves 21. The LED grooves 21 protect the LEDs 11 and reduce the chances of the LEDs 11 being erroneously broken during assembly work, so that they contribute toward improving assembly work efficiency. Still furthermore, in the present embodiment, the illumination light is effectively utilized as it is efficiently reflected from the rear surfaces of the light guide plates 4 with the reflection sheets 3 correctly kept, by the support members 2, in position along the light guide plates 4 also facilitating the reflection.

The above embodiment is only an example embodiment, and the present invention is not limited to the above embodiment. Many different embodiments can be devised using, for example, different numbers of LEDs, differently shaped components, and different installation methods without departing from the scope of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A liquid crystal display device for displaying an image using a liquid crystal panel comprising:
a plurality of light sources; and
a plurality of light guide plates to which light from the plurality of light sources is incident and which output the light incident from the plurality of light sources to the liquid crystal panel as surface light;
wherein the plurality of light guide plates are arranged along a vertical direction of the liquid crystal display device, each of the plurality of light guide plates having a rectangular shape longitudinally extending along a horizontal direction of the liquid crystal display device;
wherein an incident surface, to which light is incident from a corresponding one of the plurality of light sources, of each of the plurality of light guide plates faces up; and
wherein each of the plurality of light sources is disposed to emit light downwardly along the liquid crystal panel toward a corresponding one of the plurality of light guide plates.

2. The liquid crystal display device according to claim 1, wherein each of the plurality of light guide plates is shaped such that a thickness thereof gradually reduces along a downward direction of a display screen.

3. The liquid crystal display device according to claim 1, wherein a plurality of reflection sheets are disposed behind, as seen from in front of the display screen, the plurality of light guide plates.

4. The liquid crystal display device according to claim 1, wherein each of the plurality of light guide plates arranged in the vertical direction of the liquid crystal display device includes two light guide plate disposed side by side along the horizontal direction of the liquid crystal display device.

5. A liquid crystal display device for displaying an image using a liquid crystal panel comprising:
a plurality of light sources;
a plurality of light guide plates to which light from the plurality of light sources is incident and which output the light incident from the plurality of light sources to the liquid crystal panel as surface light;
a plurality of reflection sheets disposed behind the plurality of light guide plates; and
a plurality of support members for supporting the plurality of reflection sheets from behind;
wherein the plurality of light guide plates are arranged along a vertical direction of the liquid crystal display device, each of the plurality of light guide plates having a rectangular shape longitudinally extending along a horizontal direction of the liquid crystal display device;
wherein an incident surface, to which light is incident from a corresponding one of the plurality of light sources, of each of the plurality of light guide plates faces up;
wherein each of the plurality of light sources is disposed to emit light downwardly along the liquid crystal panel toward a corresponding one of the plurality of light guide plates; and
wherein the plurality of support members each have a hole to enclose one of the plurality of light sources.

6. The liquid crystal display device according to claim 5,
wherein each of the plurality of light guide plates has a rear side, as seen from in front of a display screen, which is curved to gradually reduce the thickness of the each of the plurality of light guide plates along a downward direction of the display screen; and
wherein the plurality of support members each have a front surface, as seen from in front of the display screen, which is curved correspondingly to a rear surface, as seen from in front of the display screen, of a corresponding one of the plurality of light guide plates.

7. The liquid crystal display device according to claim 5, wherein the hole to enclose one of the plurality of light sources has a white surface.

8. The liquid crystal display device according to claim 5, wherein each of the plurality of light guide plates arranged in the vertical direction of the liquid crystal display device includes two light guide plate disposed side by side along the horizontal direction of the liquid crystal display device.
